(19) United States
(12) Patent Application Publication
(10) Pub. No.: US 2018/0308276 A1
(43) Pub. Date: Oct. 25, 2018

(54) SYSTEMS AND METHODS FOR AUTOMATICALLY CREATING AND ANIMATING A PHOTOREALISTIC THREE-DIMENSIONAL CHARACTER FROM A TWO-DIMENSIONAL IMAGE

(71) Applicant: Mug Life, LLC, Austin, TX (US)

(72) Inventors: Robert COHEN, Austin, TX (US); Thomas COLES, Cedar Park, TX (US)

(73) Assignee: Mug Life, LLC, Austin, TX (US)

(21) Appl. No.: 15/958,893

(22) Filed: Apr. 20, 2018

Related U.S. Application Data
(60) Provisional application No. 62/488,418, filed on Apr. 21, 2017.
(60) Provisional application No. 62/491,687, filed on Apr. 28, 2017.

(51) Int. Cl. G06T 15/20; G06T 15/04; G06T 13/40; G06T 7/55; G06T 15/06

(52) U.S. Cl. CPC G06T 15/205; G06T 15/04; G06T 13/40; G06T 2207/30201; G06T 15/06; G06T 2200/08; G06T 7/55

(57) ABSTRACT

In accordance with embodiments of the present disclosure, a computer-implementable method may include receiving a two-dimensional image comprising a face of a subject, deforming a three-dimensional base head model to conform to the face in order to generate a three-dimensional deformed head model, deconstructing the two-dimensional image into three-dimensional components of geometry, texture, lighting, and camera based on the three-dimensional deformed head model, and generating a three-dimensional character from the two-dimensional image based on the deconstructing. Such method may also include animating the three-dimensional character based on the three-dimensional components and data associated with the three-dimensional deformed head model and rendering the three-dimensional character as animated based on the three-dimensional components and data associated with the three-dimensional deformed head model to a display device associated with an information handling system.

### RELATED APPLICATIONS

This application claims priority to each of U.S. Provisional Patent Application Ser. No. 62/488,418 filed on Apr. 21, 2017 and U.S. Provisional Patent Application Ser. No. 62/491,687 filed on Apr. 28, 2017, both of which are incorporated by reference herein in their entirety.

### FIELD OF DISCLOSURE

The present invention relates in general to the field of computers and similar technologies, and in particular to software utilized in this field. Still more particularly, it relates to systems and methods for automatically creating and animating a photorealistic three-dimensional character from a two-dimensional image.

### BACKGROUND

With the increased use of social media and video gaming, users of social media, video gaming, and other software applications often desire to manipulate photographs of people or animals for the purposes of entertainment or social commentary. However, existing software applications for manipulating photographs do not provide an efficient way to create or animate a photorealistic three-dimensional character from a two-dimensional image.

### SUMMARY

In accordance with the teachings of the present disclosure, certain disadvantages and problems associated with existing approaches to generating three-dimensional characters may be reduced or eliminated. For example, the methods and systems described herein may enable faster creation, animation, and rendering of three-dimensional characters as opposed to traditional techniques. In addition, the methods and systems described herein my enable fully automatic creation, animation, and rendering of three-dimensional characters not available using traditional techniques. By enabling faster and fully automatic creation, animation, and rendering of three-dimensional characters, may make three-dimensional modelling faster and easier for novices, whereas traditional techniques to three-dimensional modelling and animation generally require a high degree of time, effort, and technical and artistic knowledge.

In accordance with embodiments of the present disclosure, a computer-implementable method may include receiving a two-dimensional image comprising a face of a subject, deforming a three-dimensional base head model to conform to the face in order to generate a three-dimensional deformed head model, deconstructing the two-dimensional image into three-dimensional components of geometry, texture, lighting, and camera based on the three-dimensional deformed head model, and generating a three-dimensional character from the two-dimensional image based on the deconstructing. In some embodiments, such method may also include animating the three-dimensional character based on the three-dimensional components and data associated with the three-dimensional deformed head model and rendering the three-dimensional character as animated based on the three-dimensional components and data associated with the three-dimensional deformed head model to a display device associated with an information handling system.

In accordance with these and other embodiments of the present disclosure, a non-transitory, computer-readable storage medium embodying computer program code may comprise computer executable instructions configured for receiving a two-dimensional image comprising a face of a subject, deforming a three-dimensional base head model to conform to the face in order to generate a three-dimensional deformed head model, deconstructing the two-dimensional image into three-dimensional components of geometry, texture, lighting, and camera based on the three-dimensional deformed head model, and generating a three-dimensional character from the two-dimensional image based on the deconstructing. In some embodiments, such computer executable instructions may also be configured for animating the three-dimensional character based on the three-dimensional components and data associated with the three-dimensional deformed head model and rendering the three-dimensional character as animated based on the three-dimensional components and data associated with the three-dimensional deformed head model to a display device associated with an information handling system.

Technical advantages of the present disclosure may be readily apparent to one having ordinary skill in the art from the figures, description and claims included herein. The objects and advantages of the embodiments will be realized and achieved at least by the elements, features, and combinations particularly pointed out in the claims.

It is to be understood that both the foregoing general description and the following detailed description are explanatory examples and are not restrictive of the claims set forth in this disclosure.

### BRIEF DESCRIPTION OF THE DRAWINGS

A more complete understanding of the example, present embodiments and certain advantages thereof may be acquired by referring to the following description taken in conjunction with the accompanying drawings, in which like reference numbers indicate like features, and wherein:

FIG. 1 illustrates a block diagram of an example information handling system in which the methods and systems disclosed herein may be implemented, in accordance with embodiments of the present disclosure;

FIG. 2 illustrates a flow chart of an example method for creating and animating a photorealistic three-dimensional character from a two-dimensional image, in accordance with embodiments of the present disclosure;

FIG. 3 illustrates an example two-dimensional image comprising a human face, in accordance with embodiments of the present disclosure;

FIG. 4A illustrates an example two-dimensional image comprising a human face, in accordance with embodiments of the present disclosure;

FIG. 4B illustrates a front perspective view of a three-dimensional base head model laid over top of the human face of FIG. 4A, in accordance with embodiments of the present disclosure;

FIG. 5A illustrates a front perspective view of an example three-dimensional deformed head model laid over top of human face, in accordance with embodiments of the present disclosure;

FIG. 5B illustrates a top view depicting the extraction of a three-dimensional deformed head model from a two-dimensional image by using perspective space deformation from a three-dimensional base head model and a landmark model generated from facial landmarks extracted from a two-dimensional image;

FIG. 6 illustrates a flow chart of an example method for extraction of a three-dimensional deformed head model from a two-dimensional image using perspective space deformation, in accordance with embodiments of the present disclosure;

FIG. 7A illustrates a two-dimensional image of a human, in accordance with embodiments of the present disclosure;

FIG. 7B illustrates extraction of a color of eye whites of the subject of the two-dimensional image of FIG. 7A, in accordance with embodiments of the present disclosure;

FIG. 7C illustrates a model of irradiant light upon the subject of the two-dimensional image of FIG. 7A, in accordance with embodiments of the present disclosure;

FIG. 8 depicts a rendering of a three-dimensional character based upon the subject of the two-dimensional image of FIG. 3 on a display device, in accordance with embodiments of the present disclosure;

FIG. 9 illustrates a flow chart of an example method for the creation of interactive animation performances of a character using a keyboard of expression buttons, in accordance with embodiments of the present disclosure;

FIG. 10 illustrates an example display having a virtual keyboard of expression buttons, in accordance with embodiments of the present disclosure;

FIG. 11 illustrates an example graph of blend weight versus time for blending an expression, in accordance with embodiments of the present disclosure;

FIG. 12 illustrates an example flow diagram of applying blend operations in response to presses of expression buttons for a smile pose for applying a smile to a three-dimensional animated character and a wink animation to a three-dimensional animated character, in accordance with embodiments of the present disclosure; and

FIG. 13 illustrates a graphical depiction of a data element that may be used by an image processing system to store the sequence and timing of expression buttons for later transmission and/or playback of interactive expression sequences, in accordance with embodiments of the present disclosure.

### DETAILED DESCRIPTION

For the purposes of this disclosure, an information handling system may include any instrumentality or aggregation of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal data assistant (PDA), a consumer electronic device, a mobile device such as a tablet or smartphone, a connected “smart device,” a network appliance, a network storage device, or any other suitable device and may vary in size, shape, performance, functionality, and price. The information handling system may include volatile and/or non-volatile memory, and one or more processing resources such as a central processing unit (CPU) or hardware or software control logic. Additional components of the information handling system may include one or more storage systems, one or more communications ports for communicating with networked devices, external devices, and various input and output (I/O) devices, such as a keyboard, a mouse, a video display, and/or an interactive touchscreen. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

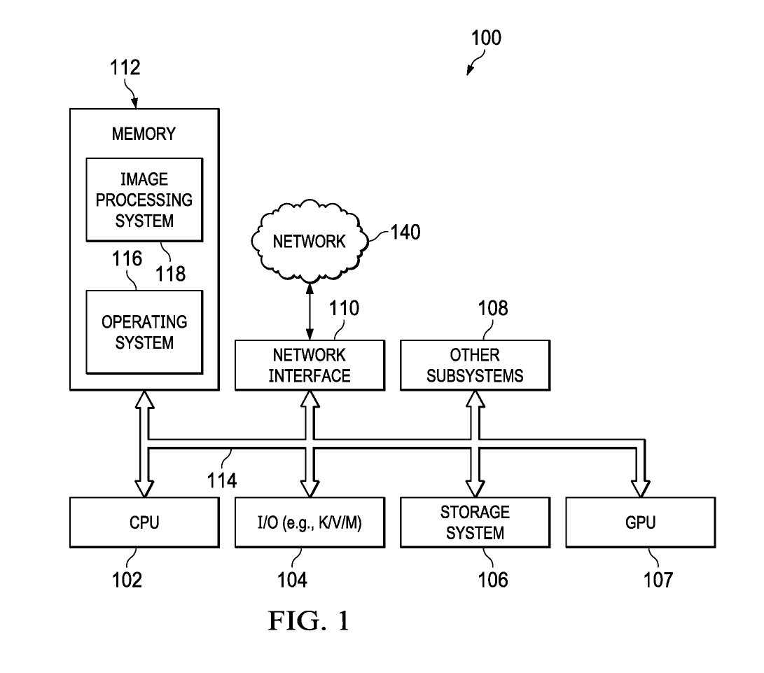

FIG. 1 illustrates a block diagram of an example information handling system 100 in which the methods and systems disclosed herein may be implemented, in accordance with embodiments of the present disclosure. Information handling system 100 may include a processor (e.g., central processor unit or “CPU”) 102, input/output (I/O) devices 104 (e.g., a display, a keyboard, a mouse, an interactive touch screen, a camera, and/or associated controllers), a storage system 106, a graphics processing unit (“GPU”) 107, and various other subsystems 108. GPU 107 may include any system, device, or apparatus configured to rapidly manipulate and alter memory to accelerate the creation of images in a frame buffer intended for output to a display. Although FIG. 1 depicts GPU 107 separate from and communicatively coupled to CPU 102, in some embodiments GPU 107 may be an integral part of CPU 102).

In various embodiments, information handling system 100 may also include network interface 110 operable to couple, via wired and/or wireless communication, to a network 140 (e.g., the Internet or other network of information handling systems). Information handling system 100 may also include system memory 112, which may be coupled to the foregoing via one or more buses 114. System memory 112 may store operating system (OS) 116 and in various embodiments may also include an image processing system 118. In some embodiments, information handling system 100 may be able to download image processing system 118 from network 140. For example, in embodiments in which information handling system 100 comprises a mobile device (e.g., tablet or smart phone), a user may interact with information handling system 100 to instruct information handling system 100 to download image processing system 118 from an application “store” and install image processing system 118 as an executable software application in system memory 112. In these and other embodiments, image processing system 118 may be provided as a service (e.g., software as a service) from a service provider within network 140.

In accordance with embodiments of this disclosure, image processing system 118 may be configured to automatically create and animate a photorealistic three-dimensional character from a two-dimensional image. For example, in operation, image processing system 118 may automatically create and animate a photorealistic three-dimensional character from a two-dimensional image by deconstructing the two-dimensional image into three-dimensional geometry, texture, lighting, and camera components, animating the geometry and texture using blend shape data, and rendering the animated three-dimensional character on a display (e.g., a video monitor or a touch screen) of an information handling system.

In some embodiments, image processing system 118 and the functionality thereof may improve processor efficiency, and thus the efficiency of information handling system 100, by performing image manipulation operations with greater efficiency and with decreased processing resources as compared to existing approaches for similar network security operations. In these and other embodiments, image processing system 118 and the functionality thereof may improve effectiveness of creating and animating three-dimensional images, and thus the effectiveness of information handling system 100, by enabling users of image processing system 118 to more easily and effectively create three-dimensional characters and/or animate three-dimensional characters with greater effectiveness than that of existing approaches for creation and animation of three-dimensional characters. To that end, the creation and/or animation of a three-dimensional character from a two-dimensional image is valuable for a large variety of real-world applications, including without limitation video game development, social networking, image editing, three-dimensional animation, and efficient transmission of video.

As will be appreciated, once information handling system 100 is configured to perform the functionality of image processing system 118, information handling system 100 becomes a specialized computing device specifically configured to perform the functionality of image processing system 118, and is not a general purpose computing device. Moreover, the implementation of functionality of image processing system 118 on information handling system 100 improves the functionality of information handling system 100 and provides a useful and concrete result of improving image creation and animation using novel techniques as disclosed herein.

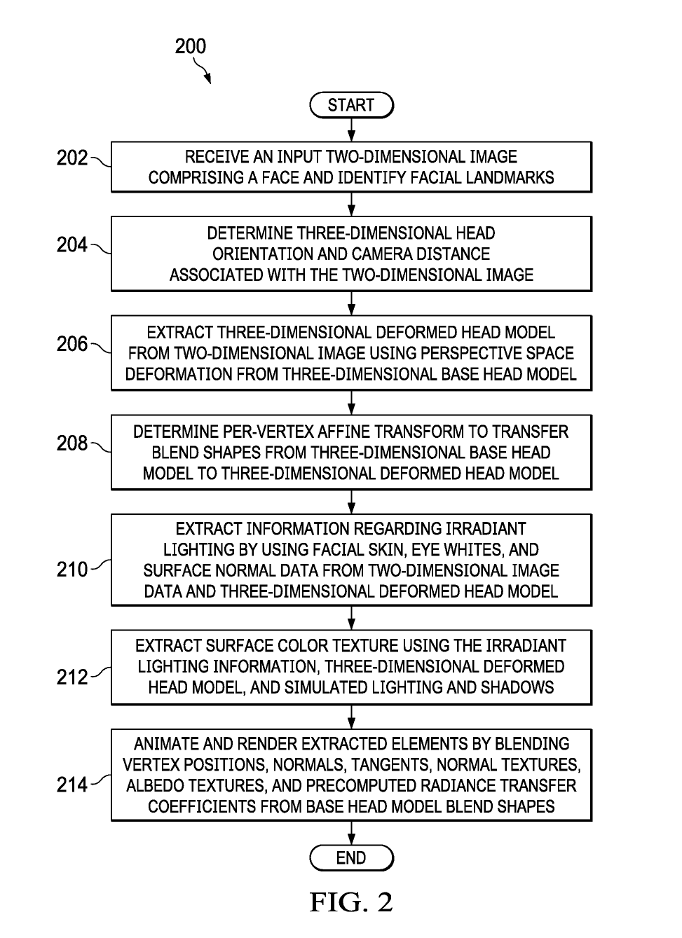

FIG. 2 illustrates a flow chart of an example method 200 for creating and animating a photorealistic three-dimensional character from a two-dimensional image, in accordance with embodiments of the present disclosure. According to some embodiments, method 200 may begin at step 202. As noted above, teachings of the present disclosure may be implemented in a variety of configurations of information handling system 100. As such, the preferred initialization point for method 200 and the order of the steps comprising method 200 may depend on the implementation chosen.

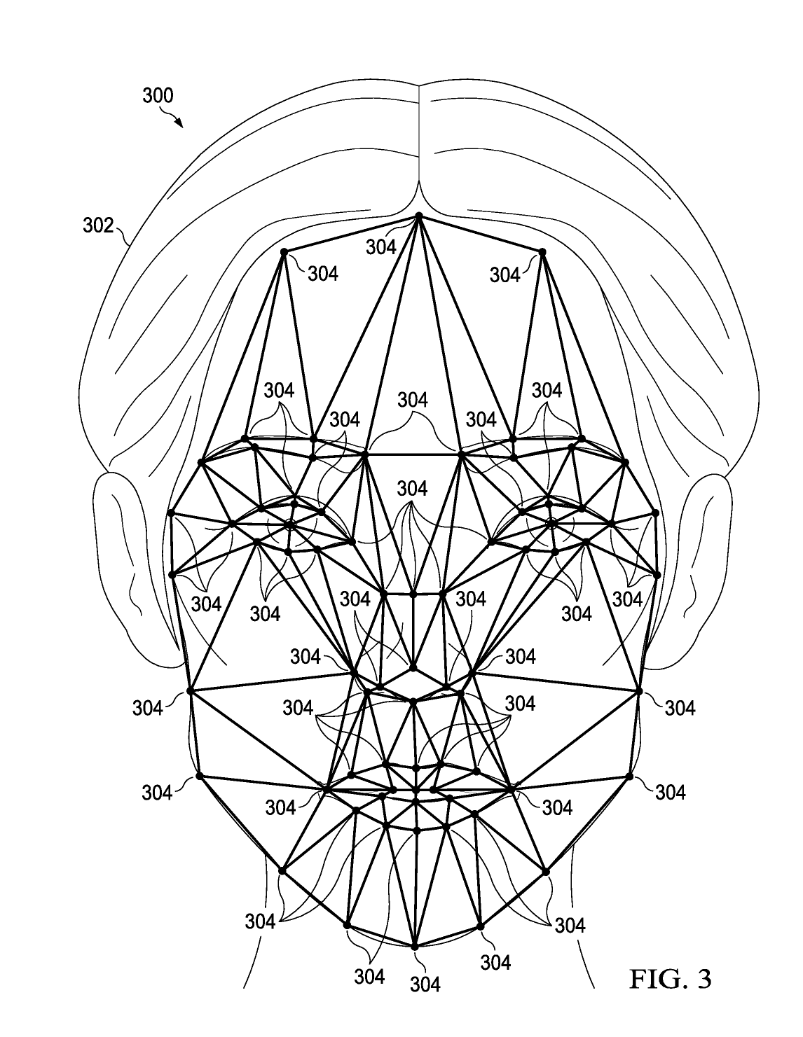

At step 202, image processing system 118 may receive as an input a two-dimensional image comprising a face and may identify a plurality of facial landmarks using automatic facial recognition or may identify a plurality of facial landmarks based on user input regarding the location of such facial landmarks within the two-dimensional image. To further illustrate the actions performed at step 202, reference is made to FIG. 3. FIG. 3 illustrates an example two-dimensional image 300 comprising a human face 302, in accordance with embodiments of the present disclosure. In accordance with step 202 of method 200, image processing system 118 may receive two-dimensional image 300 as an input. For example, two-dimensional image 300 may comprise a photograph taken by a user of information handling system 100 using a built-in camera of information handling system 100 or an electronic file downloaded or otherwise obtained by the user and stored in system memory 112. As shown in FIG. 3, a plurality of facial landmarks 304 may be identified either “by hand” by a user identifying the location of such facial landmarks 304 within two-dimensional image 300 via interaction through I/O devices 104 of information handling system 100 or using automatic facial recognition techniques to determine the location of such facial landmarks 304. As used herein, facial landmarks 304 may comprise a defining feature of a face, such as, for example, corners or other points of a mouth, eye, eyebrow, nose, chin, cheek, hairline, and/or other feature of face 302. Although FIG. 3 depicts a particular number (e.g., 76) of facial landmarks 304, any other suitable number of facial landmarks 304 may be used (e.g., 153). Once facial landmarks 304 have been identified, image processing system 118 may identify a plurality of triangles with facial landmarks 304 as vertices of such triangles in order to form an image landmark model for two-dimensional image 300. In some embodiments, once facial landmarks 304 have been identified, image processing system 118 may allow a user, via I/O devices 104, to manually tune and/or manipulate the locations of facial landmarks 304.

Although two-dimensional image 300 shown in FIG. 3 depicts an actual photograph, it is understood that any image, whether a photograph, computer-generated drawing, or hand-drawn image may be used as an input for image processing system 118. In addition, although two-dimensional image 300 shown in FIG. 3 depicts an actual, real-life human face, an image of any face (e.g., human, animal, statue, tattoo, etc.) or any image having features that can be analogized to features of a human face (e.g., face-like patterns in inanimate objects), may be used as an input for image processing system 118.

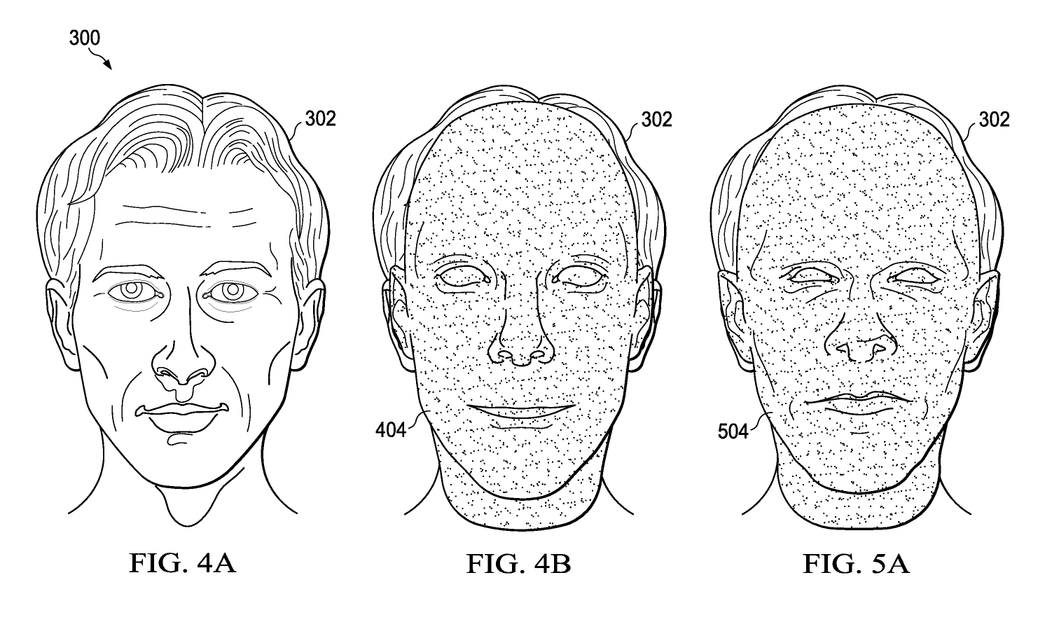

Turning again to FIG. 2, at step 204, image processing system 118 may determine a three-dimensional head orientation and a camera distance associated with the two-dimensional image. In step 204, image processing system 118 may determine the orientation of a three-dimensional model of a head, relative to an actual or hypothetical camera. To further illustrate the actions performed at step 204, reference is made to FIGS. 4A and 4B. FIG. 4A illustrates an example two-dimensional image 300 comprising a human face 302 and FIG. 4B illustrates a front perspective view of a three-dimensional base head model 404 laid over the top of human face 302 and oriented to match two-dimensional image 300, in accordance with embodiments of the present disclosure. Three-dimensional base head model 404 may comprise any suitable three-dimensional model of a head, and may include the same respective facial landmarks as those which are identified in a two-dimensional image in step 202, above.

The orientation of a three-dimensional head model may be described with nine parameters: xposition, yposition, distance, xscale, yscale, zscale, xrotation, yrotation, and zrotation. Each of these nine parameters may define a characteristic of the two-dimensional image as compared to a three-dimensional base head model which includes facial landmarks analogous to facial landmarks 304 identified in the two-dimensional image. The parameter xposition may define a positional offset of face 302 relative to an actual camera (or other image capturing device) or hypothetical camera (e.g., in the case that two-dimensional image 300 is a drawing or other non-photographic image) in the horizontal direction at the point of viewing perspective of two-dimensional image 300. Similarly, the parameter yposition may define a positional offset of face 302 relative to the actual or hypothetical camera in the vertical direction. Likewise, parameter distance may define a positional offset of face 302 relative to an actual or hypothetical camera in the direction the camera is pointed (e.g. a direction perpendicular to the plane defining the two dimensions of two-dimensional image 300).

The parameter xscale may define a width in the horizontal direction of face 302 relative to that of three-dimensional base head model 404. Similarly, the parameter yscale may define a height in the vertical direction of face 302 relative to that of three-dimensional base head model 404, and parameter zscale may define a depth in a direction perpendicular to the horizontal and vertical directions of face 302 relative to that of three-dimensional base head model 404. Parameter xrotation may define an angular rotation of face 302 relative to the horizontal axis of the actual or hypothetical camera. Similarly, parameter yrotation may define an angular rotation of face 302 in the vertical axis of the actual or hypothetical camera. Likewise, parameter zrotation may define an angular rotation of face 302 in the depth axis (i.e., perpendicular to the horizontal axis and the vertical axis) of the actual or hypothetical camera. Parameter distance may define an estimated distance along the depth direction between face 302 and the actual camera or the hypothetical camera at the point of viewing perspective of two-dimensional image 300.

In order to reduce a solution space for faster convergence of values for these various parameters, image processing system 118 may directly compute parameters xposition and ypositon based on a particular point defined by one or more facial landmarks 304 (e.g., a midpoint between inner corners of the eyes of the image subject). In addition, image processing system may estimate parameter zscale as the average of parameters xscale and yscale. This direct computation and estimation leaves six unknown parameters: xscale, yscale, xrotation, yrotation, zrotation, and distance.

To determine the values for these six unknown parameters, image processing system 118 may compute an error value for each iteration until image processing system 118 converges upon an optimal solution for the six parameters (e.g., a solution with the lowest error value). Such error value for each iteration may be based on a weighted sum of two error quantities: distance error and shading error. The distance error may be calculated as a root-mean-square distance between facial landmarks of two-dimensional image 300 and corresponding facial landmarks of three-dimensional base head model 404 oriented using the nine parameters. An ideal distance error may be zero. The shading error may be a measure of difference in shading at vertices of three-dimensional base head model 404 and pixel colors of two-dimensional image 300. Shading error may be computed using vertex positions and normals of three-dimensional base head model 404 by orienting them using the nine orientation parameters. The corresponding colors for each vertex can then be determined by identifying the closest pixel of two dimensional image 300. Once the oriented normals and colors are known for visible skin vertices, the surface normals and colors may be used to compute spherical harmonic coefficients. A surface normal may comprise a unit vector which indicates the direction a surface is pointing at a given point on the surface. A three-dimensional model may have a plurality of skin vertices, wherein each skin vertex may be given by position (x,y,z), and may have other additional attributes such as a normal (nx,ny,nz) of each visible skin vertex. For example, in some embodiments of the present disclosure, three-dimensional base head model 404 may have 4,665 skin vertices. Image processing system 118 may use normal and colors to compute spherical harmonic coefficients. The evaluation of the spherical harmonic function for each vertex normal may be compared to the corresponding pixel of two-dimensional image 300 to compute a root mean square shading error. The ideal shading error may be zero.

To further illustrate, two-dimensional image 300 has a plurality of pixels, each pixel having a color on each pixel. Three-dimensional base head model 404 may serve as a best guess of a three-dimensional orientation of a head. Each vertex on the surface of three-dimensional base head model 404 may have a surface normal describing the direction that surface points. Image processing system 118 may align two-dimensional image 300 with three-dimensional base head model 404, and then determine for each vertex of three-dimensional base head model 404 the color of the image pixel of two-dimensional image 300 corresponding to the vertex. Now that image processing system 188 has a color and direction for each vertex, image processing system 118 may fit a spherical harmonic function to the data. Because facial skin of a human may be a consistent color, if the surface normals were accurate, the fitted spherical harmonic function should accurately predict the colors at each direction. This approach may work as an effective way to use shading to measure the accuracy of the orientation of three-dimensional base head model 404. The combination of the landmark positional error with the vertex shading error may provide a very reliable error metric. Thus, as described below, the landmark positional error and the vertex shading error may be used by image processing system to iteratively solve for the six unknown orientation parameters with the minimum error.

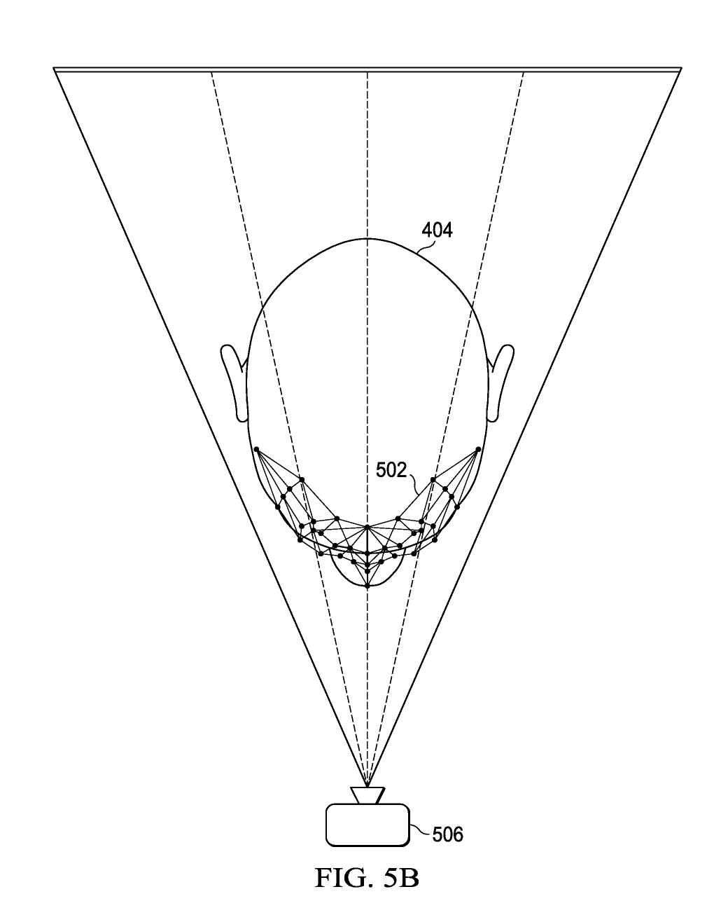

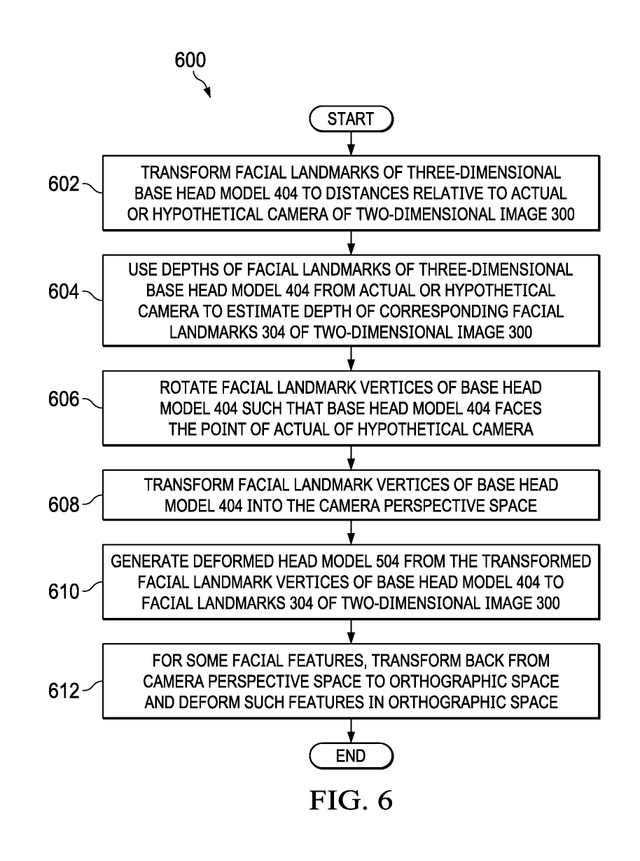

Turning again to FIG. 2, at step 206, image processing system 118 may extract a three-dimensional deformed head model from the two-dimensional image by using perspective space deformation (e.g., warping) from a three-dimensional base head model. In other words, once three-dimensional base head model 404 is oriented to align with two-dimensional image 300 in step 204, the facial landmarks extracted at step 202 may be used to deform three-dimensional base head model 404 to match face 302 of two-dimensional image 300. In order to maximize the quality of the deformation, image processing system 118 may use the six parameters determined in step 204 above to compute the deformation in the perspective space of the actual camera used in two-dimensional image 300, or from the perspective space of a hypothetical camera in the case where two-dimensional image 300 is a drawing or other non-photographic image. The resulting three-dimensional deformed head model may be a close match to face 302 in image 300. To further illustrate the actions performed at step 206, reference is made to FIGS. 5A, 5B, and 6. FIG. 5A illustrates a front perspective view of an example three-dimensional deformed head model 504 laid over top of human face 302, in accordance with embodiments of the present disclosure. FIG. 5B illustrates a top view depicting the extraction of three-dimensional deformed head model 504 from two-dimensional image 300 by using perspective space deformation in the perspective of a camera 506 from three-dimensional base head model 404 and a landmark model 502 generated from facial landmarks 304 extracted from two-dimensional image 300.

FIG. 6 illustrates a flow chart of an example method 600 for extraction of three-dimensional deformed head model 504 from two-dimensional image 300 using perspective space deformation, in accordance with embodiments of the present disclosure. According to some embodiments, method 600 may begin at step 602. As noted above, teachings of the present disclosure may be implemented in a variety of configurations of information handling system 100. As such, the preferred initialization point for method 600 and the order of the steps comprising method 600 may depend on the implementation chosen.

At step 602, image processing system 118 may transform facial landmarks of three-dimensional base head model 404 to distances relative to actual or hypothetical camera 506 of two-dimensional image 300. At step 604, image processing system 118 may use depths of the facial landmarks of three-dimensional base head model 404 from actual or hypothetical camera 506 to estimate depth of corresponding facial landmarks 304 of two-dimensional image 300. At step 606, now that facial landmarks 304 of two-dimensional image 300 include three-dimensional depths, image processing system 118 may rotate facial landmark vertices of base head model 404 such that base head model 404 “looks” toward or faces the point of actual or hypothetical camera 506. Such rotation may minimize potential problems associated with streaking textures and self-occlusion during processing of two-dimensional image 300. At step 608, using the head orientation resulting from step 606 and the parameter distance determined as described above, image processing system 118 may transform facial landmark vertices of base head model 404 into the perspective space of actual or hypothetical camera 506. In other words, image processing system 118 may transform facial landmark vertices of base head model 404 into coordinates based on respective distances of such facial landmark vertices from actual or hypothetical camera 506.

At step 610, image processing system 118 may generate deformed head model 504 based on the offset from landmark model 502 to facial landmarks 304 of two-dimensional image 300. For each triangle defined by facial landmarks of landmark model 502, a two-dimensional affine transform may be computed. In some embodiments, such a two-dimensional affine transform may be performed using code analogous to that set forth below. The two-dimensional affine transforms may transform vertices of base head model 404 inside of the triangles of landmark model 502. Any vertices appearing outside the triangles of landmark model 502 may use transforms from border triangles of the triangles of landmark model 502, weighted by triangle area divided by distance squared. During step 610, image processing system 118 may use positions of facial landmarks 304 of two-dimensional image 300 to transfer texture coordinates to deformed head model 504, which may later be used by image processing system 118 to map extracted color texture onto deformed head model 504. Image processing system 118 may use the same interpolation scheme as the interpolation scheme for positions of facial landmarks 304. All or a portion of step 610 may be executed by the following computer program code, or computer program code similar to that set forth below:

```
Matrix2×3 CalcAffineTransform(Vector3 a0, Vector3 b0, Vector3
c0,
    Vector3 a1, Vector3 b1, Vector3 c1)
{
  Matrix2x3 m;
  float det = b0.x*c0.y − b0.x*a0.y − a0.x*c0.y
    − c0.x*b0.y + a0.x*b0.y + c0.x*a0.y;
  // factor in weight with det
  float invDet = 1.0f/det;
  float ms00 = c0.y − a0.y;
  float ms01 = −b0.y + a0.y;
  float ms10 = −c0.x + a0.x;
  float ms11 = b0.x − a0.x;
  float md00 = b1.x − a1.x;
  float md01 = b1.y − a1.y;
  float md10 = c1.x − a1.x;
  float md11 = c1.y − a1.y;
  // compute upper 2×2
  m.m00 = invDet*(ms00*md00 + ms01*md10);
  m.m01 = invDet*(ms00*md01 + ms01*md11);
  m.m10 = invDet*(ms10*md00 + ms11*md10);
  m.m11 = invDet*(ms10*md01 + ms11*md11);
  // compute translation
  m.m20 = a1.x − (a0.x*m.m00 + a0.y*m.m10);
  m.m21 = a1.y − (a0.x*m.m01 + a0.y*m.m11);
  return m;
}
```

While deforming in perspective space works well for surface features, it may create undesirable distortions below the surface. Thus, in order to minimize such undesirable distortions, at step 612, for some facial features (e.g., the mouth), image processing system 118 may transform back from perspective space of actual or hypothetical camera 506 to orthographic space, perform transformations to such features (e.g., close the mouth, if required), and deform such features in orthographic space.

To illustrate the terms “perspective space” and “orthographic space” as used herein, it is noted that a three-dimensional transform translates input positions to output positions. Different three-dimensional transforms may scale space, rotate space, warp space, and/or any other operation. In order to take a three-dimensional position and emulate the viewpoint from a camera, image processing system 118 pay perform a perspective transform. The post-perspective transform positions may be said to be in “perspective space.” While in perspective space, image processing system 118 may perform various operations on the post-perspective transform positions, such as the three-dimensional deformation or “warp” described above. “Orthographic space” may refer to the original non-perspective space, e.g., a three-dimensional model without the perspective transform (or in other words, the perspective space model with an inverse of the perspective transform applied to it).

Although FIG. 6 discloses a particular number of steps to be taken with respect to method 600, method 600 may be executed with greater or fewer steps than those depicted in FIG. 6. In addition, although FIG. 6 discloses a certain order of steps to be taken with respect to method 600, the steps comprising method 600 may be completed in any suitable order.

Method 600 may be implemented using CPU 102, image processing system 118 executing thereon, and/or any other system operable to implement method 600. In certain embodiments, method 600 may be implemented partially or fully in software and/or firmware embodied in computer-readable media.

Turning again to FIG. 2, at step 208, image processing system 118 may determine a per-vertex affine transform to transfer blend shapes from three-dimensional base head model 404 to the three-dimensional deformed head model 504. In some embodiments, three-dimensional base head model 404 may be generated from a high-resolution three-dimensional scan of a person with suitably average facial features. Furthermore, image processing system 118 may use a plurality (e.g., approximately 50) of blend shape models from high-resolution three-dimensional scans to represent various human expressions. In addition, image processing system 118 may reduce the high-resolution base and blend shape models to lower-resolution models with matching topology, including corresponding normal and texture maps to encode the high-resolution surface data. Moreover, image processing system 118 may translate the reduced-resolution blend shape models in order to operate effectively with the three-dimensional deformed head model generated in step 206.

To perform step 208, image processing system 118 may begin with the landmark model affine transforms used to generate the three-dimensional deformed head model generated in step 206. Image processing system 118 may ignore those triangles defined by facial landmarks 304 of two-dimensional image 300 associated with the lips of the subject of two-dimensional image 300, due to high variance in lip scale and problems that might arise if the mouth of the subject in two-dimensional image 300 was open. Image processing system 118 may further set an upper limit on transform scale, in order to reduce the influence of spurious data. Subsequently, image processing system 118 may perform multiple area-weighted smoothing passes wherein the affine transforms are averaged with their adjacent affine transforms. Image processing system 118 may then load each triangle vertex in landmark model 502 with the area-weighted affine transforms of the triangles of landmark model 502. After smoothing, image processing system 118 may offset the translation portion of each vertex of landmark model 502 so that a source facial landmark vertex transformed by its smoothed affine transform equals a corresponding destination landmark vertex.

At this point, each vertex of landmark model 502 may have a corresponding affine transform that will move it towards a target model, with affine scaling smoothly influenced by its neighboring vertices. Image processing system 118 may interpolate these affine transforms of landmark model 502 for every vertex in three-dimensional deformed head model 504.

For facial landmark vertices of three-dimensional base head model 404 within the triangles of landmark model 502, image processing system 118 may use linear interpolation between any two overlapping landmark triangles of landmark model 502. For any facial landmark vertices appearing outside the triangles of landmark model 502, image processing system 118 may use interpolated transforms from the closest point border triangles of landmark model 502, weighted by triangle area divided by distance squared. Image processing system 118 may store the final interpolated affine transform for each vertex stored with the corresponding three-dimensional deformed head model 504 vertex. Now that an affine transform has been computed for each deformed model vertex, image processing system 118 may transform each blend shape vertex into the corresponding affine transform to produce blend shapes for three-dimensional deformed head model 504.

At step 210, image processing system 118 may extract information regarding irradiant lighting by using facial skin surface color and eye white color from image data of two-dimensional image 300, and surface normal data from three-dimensional deformed head model 504. The incoming light from various directions and incident upon the subject of two-dimensional image 300 can also be referred to as irradiance or irradiant light. Extracting the irradiant light from a two-dimensional image may be necessary to render three-dimensional objects in a manner such that they look natural in the environment, with proper lighting and shadows. Image processing system 118 may align three-dimensional deformed head model 504 and the position of the actual or hypothetical camera 506 to two-dimensional image 300 and may ray-trace or rasterize to determine a surface normal at every pixel in original two-dimensional image 300. Image processing system 118 may mask (e.g., based on facial landmarks 304) to isolate those areas that are expected to have a relatively constant skin surface color. Image processing system 118 may exclude the eyes, mouth, hair, and/or other features of the subject of two-dimensional image 300 from the determination of irradiant light.

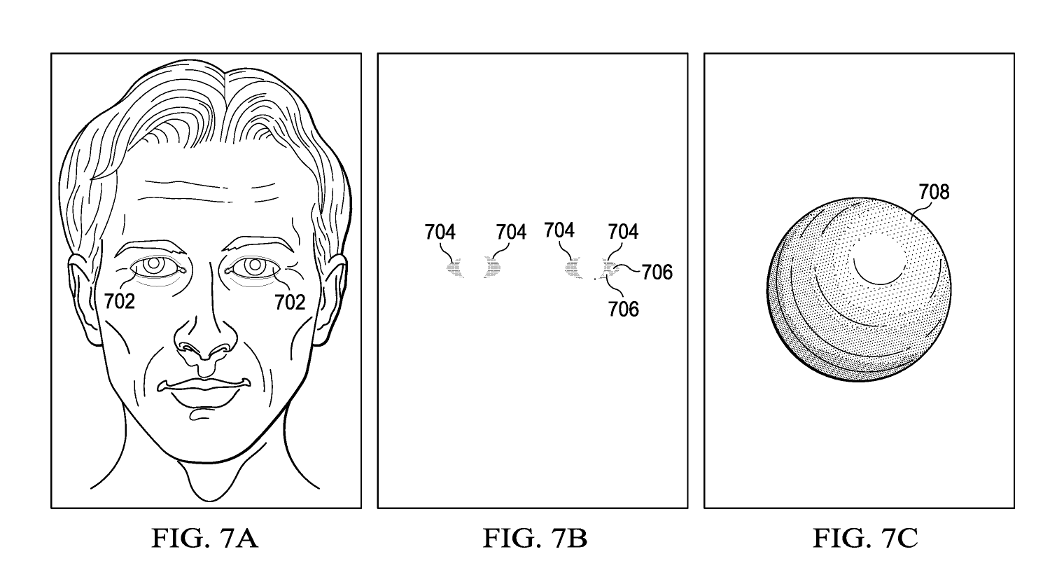

For these skin pixels, image processing system 118 may use a model normal and pixel color to compute spherical harmonic coefficients of skin radiance. These color values may represent a combination of skin color and irradiant light for every skin pixel. Next, image processing system 118 may use facial landmarks 304 to identify the color of the whites of the eyes of the subject of two-dimensional image 300. For example, image processing system 118 may, as shown in FIGS. 7A and 7B, sample the eye areas 702 outside of the pupil in order to identify a color for the whites of the eyes. Image processing system 118 may ignore over-exposed pixels in such analysis, as such pixels may lack accurate color data. After over-exposed pixels are excluded, image processing system 118 may average the brightest pixels to create an initial eye color estimate. As shown in FIG. 7B, the result of such sampling may result in: candidate pixels 704 identified as eye whites and brightest eye white pixels 706 excluding pixels that are over-exposed. Image processing system 118 may average these brightest eye white pixels 706 to determine a reference neutral white color and neutral luminance.

Image processing system 118 may then further process the initial eye color estimate depending on other factors associated with two-dimensional image 300. For example, if the eye luminance is greater than an average skin luminance of the subject of two-dimensional image 300, image processing system 118 may use the initial eye color estimate as is. As another example, if the eye luminance is between 50% and 100% of the average skin luminance, image processing system 118 may assume the eyes are in shadow, and image processing system 118 may scale the eye luminance to be equal to the average skin luminance, while maintaining the measured eye white color. As a further example, if eye luminance is less than 50% of the average skin luminance, or no eye white pixels were found, image processing system 118 may assume the determination of eye luminance to be a bad reading. Such a bad reading may occur if the eyes are obscured by sunglasses or if no eye whites are visible (e.g., where the subject of two-dimensional image 300 is a non-human animal or cartoon character). In this case, image processing system 118 may assume the eye white color to be neutrally colored white, with a luminance equal to a default ratio of the average skin luminance (e.g., a ratio of 4:3 in accordance with a typical eye luminance reading).

Once the eyes have been analyzed to identify the color of white surfaces under the lighting conditions of two-dimensional image 300, image processing system 118 may convert spherical harmonic coefficients for skin radiance to spherical harmonic coefficients for light irradiance, thus generating a spherical harmonic 708 as depicted in FIG. 7C that may be evaluated to compute incoming (irradiant) light from any direction, independent of surface color.

In order to convert from skin radiance to light irradiance, image processing system 118 may, for each spherical harmonic coefficient, i, calculate light irradiance for each color channel (e.g., red, green, and blue):
RedIrradianceSH[i]=RedSkinRadianceSH[i]×EyeWhiteRed/AverageSkinColorRed
GmIrradianceSH[i]=GrnSkinRadianceSH[i]×EyeWhiteGrn/AverageSkinColorGrn
BlueIrradianceSH[i]=BlueSkinRadianceSH[i]*EyeWhiteBlue/AverageSkinColorBlue
   In some embodiments, image processing system 118 may use second-order spherical harmonics with nine coefficients per color channel, which may provide a good balance between accuracy and computational efficiency.

Turning again to FIG. 2, at step 212, image processing system 118 may extract surface color texture using the irradiant lighting information, three-dimensional deformed head model 504, and simulated lighting and shadows. In order to accurately render an animated model, image processing system 118 may require the surface color texture of three-dimensional deformed head model 504 with lighting removed. To that end, image processing system 118 may determine a final pixel color in an image in accordance with a rendering equation:

Pixel Color=Irradiant Light*Shadow Occlusion*Surface Color

wherein the Pixel Color may be defined by each pixel in original two-dimensional image 300. The Irradiant Light used in the equation is the irradiant light extracted in step 210, and may be computed for pixels on the head of the subject of two-dimensional image 300 using the normal of three-dimensional deformed head model 504 (extracted in step 206) and applying ray tracing. Image processing system 118 may calculate Shadow Occlusion by using the position and normals from three-dimensional deformed head model 504. Although shadow occlusion may be computed in a variety of ways (or even not at all, with reduced quality), in some embodiments image processing system 118 may use a hemispherical harmonic (HSH) shadow function, using vertex coefficients generated offline with ray tracing and based on three-dimensional base head model 404. Such method may execute quickly during runtime of image processing system 118, while still providing high-quality results. Such method may also match the run-time shadowing function (described below) which image processing system 118 uses to render three-dimensional deformed head model 504. The Surface Color used in the equation above is unknown, but may be determined as set forth below.

Image processing system 118 may use a lighting function to render the final result of the image processing, and such lighting function may be the inverse of the lighting function used to generate the surface color texture, thus insuring that the final result may be significantly identical to original two-dimensional image 300. Stated in equation form:

LightingFuncton(InverseLightingFunction(Pixel Color))=Pixel Color

Written another way:

Surface Color=Pixel Color/(Irradiant Light×Shadow Occlusion)

Image processing system 118 may use this approach to generate every pixel in the surface color texture, and use the texture mapping generated in step 206 to project such texture onto three-dimensional deformed head model 504. Generating the surface in this manner may have the benefit of cancelling out errors in extracted data associated with three-dimensional deformed head model 504, and may be a key to achieving high-quality results. For example, if image processing system 118 underestimates brightness in an area of a face of a subject of two-dimensional image 300, the surface color pixels in that area may be brighter than the true value. Later, when image processing system 118 renders the three-dimensional model in the original context, and again underestimates the brightness, the rendered pixel may be brightened the appropriate amount by the extracted color texture. This cancellation may work well in the original context—the same pose and same lighting as original two-dimensional image 300. The more the pose or lighting deviates from original two-dimensional image 300, the more visible the errors become in the resulting rendered three-dimensional image. For this reason, it may be desirable for all the extracted data to be as accurate as possible.

Because computation of Surface Color in the above equation may become erratic as the denominator (Irradiant Light×Shadow Occlusion) approaches zero, image processing system 118 may enforce a lower bound (e.g., 0.075) for the denominator. Although enforcing such bound may introduce an error in rendering, the presence of such error may be acceptable, as such error may be hidden in shadows of the image at time of image rendering.

In addition, problems may occur when a computed surface color is greater than 1.0, because standard textures have a limited range between 0.0 and 1.0. Because real surface colors are not more than 100% reflective, this issue usually does not pose a problem. However, in the present disclosure, image processing system 118 may require surface color values greater than 1.0 so that the combination of the inverse lighting and forward lighting will produce identity and avoid objectionable visual artifacts. However, to reduce or eliminate this problem, image processing system 118 may scale the surface color down by a scaling factor (e.g., 0.25) and scale it back up by the inverse of the scaling factor (e.g., 4.0) at rendering. Such scaling may provide a surface color dynamic range of 0.0 to the inverse scaling factor (e.g., 4.0), which may be sufficient to avoid objectionable artifacts. Furthermore, image processing system 118 may use a lighting mask to seamlessly crossfade the areas outside the face of the subject of two-dimensional image 300 back to original two-dimensional image 300.

At step 214, image processing system 118 may animate and render the extracted elements on a display of information handling system 100 by blending vertex positions, normals, tangents, normal textures, albedo textures, and precomputed radiance transfer coefficients from a library of base head model blend shapes. By doing so, image processing system 118 may provide for the three-dimensional animation and rendering of the face and head of the subject of two-dimensional image 300. Image processing system 118 may often request a large number of simultaneous blend shapes. Using every blend shape would be computationally expensive and cause inconsistent frame rates. Many of the blend shapes have small weights, and don't make a significant contribution to the final result. For performance purposes, it may be faster for image processing system 118 to drop the blend shapes with the lowest weights, but simply dropping the lowest weights can result in visible artifacts (e.g., popping) as blend shapes are added and removed.

In operation, image processing system 118 may enable real-time character animation by performing blend shape reduction without discontinuities. With available data, image processing system 118 may start with a plurality (e.g., 50) requested blend shapes, but it may be necessary to reduce that down to 16 blend shapes for vertex blending and 8 blend shapes for texture blending in order to effectively animate and render. Accordingly, image processing system 118 may first sort blend shapes by weight. If there are more blend shapes than a predetermined maximum, image processing system 118 may apply the following technique to scale down the lowest weight allowed into the reduced set:
WA=BlendShapeWeights[MaxAllowedBlendShapes−2]
WB=BlendShapeWeights[MaxAllowedBlendShapes−1]
WC=BlendShapeWeights[MaxAllowedBlendShapes]
ReduceScale=1.0−(WA−WB)/(WA−WC)
BlendShapeWeights[MaxAllowedBlendShapes−1]*=ReduceScale

In addition, image processing system 118 may enable real-time character animation by performing high-quality vertex animation from blend shapes onto three-dimensional deformed head model 504, using affine transforms from step 210. To illustrate, during an offline preprocessing stage, reduced resolution base models and blend shape models may undergo intensive computation to produce precomputed radiance transfer (PRT) coefficients for lighting. Each blend shape may include positions, normals, tangents, and PRT coefficients. Image processing system 118 may later combine PRT coefficients at runtime to reproduce complex shading for any extracted lighting environment (e.g., from step 210) Rather than storing a single set of PRT coefficients per blend shape, image processing system 118 may store a plurality (e.g., four) of sets of PRT coefficients to provide improved quality for nonlinear shading phenomena. In some embodiments, the number of PRT sets may be selected based on tradeoffs between trade shading quality and required memory capacity.

At runtime, image processing system 118 may blend the blend shapes with base head model 404 to compute a final facial pose, including position, normals, tangents, and PRT coefficients. Image processing system 118 may further use regional blending to allow for independent control of up to eight different regions of the face. This may allow for a broad range of expressions using a limited number of source blend shapes.

At first, image processing system 118 may compute a list of blend shape weights for each facial region, sort the blend shapes by total weight, and reduce the number of blend shapes (e.g., from 50 blend shapes down to 16 blend shapes) as described above. Image processing system 118 may then divide base head model 404 into slices for parallel processing, and to reduce the amount of computational work that needs to be performed. If a model slice has a vertex range that does not intersect the regions requested to be animated, the blend shape can be skipped for that slice. Similarly, if there is a partial overlap, processing can be reduced to a reduced number of vertices. This results in a substantial savings of computing resources.

Image processing system 118 may apply to the following operations to each model slice:
1) The model vertex positions are set to zero.
2) The model vertex normal, tangent, and PRT coefficient values are set equal to the base model.
3) For each active blend shape:
   1. The model slice's vertex range is compared to the active regions' vertex range. If there is no overlap, the blend shape can be skipped. If there is a partial overlap, the vertex range for computation is reduced.
   2. Based on the blend shape's maximum region weight (MaxWeight), the active PRT coefficient sets and weights are determined.
      1. For (MaxWeight <=0), index0=0, index1=1, PRTweight0=0, PRTweightl=0
      2. For (MaxWeight >=1), index0=steps-1, index1=steps-1, PRTweight0=1/weight, PRTweightl=0
      3. For (MaxWeight <=1/steps), index0=0, index1=0, PRTweight0=steps, PRTweightl=0
      4. For (MaxWeight >1/steps),
         1. fu=weight*steps−1
         2. index0=min((int) fu, steps−2)
         3. index1=index0+1
         4. PRTweightl=(fu−index0/MaxWeight
         5. PRTweight0=(1−PRTweightl)/MaxWeight
   3. For each vertex in the model slice
      1. VertexWeight=0
      2. For each region, r
         1. VertexWeight+=ShapeRegionWeight[r]*meshRegionWeight[r]
      3. VertexPosition+=VertexWeight*BlendShapePosition
      4. VertexNormal+=VertexWeight*BlendShapeNormal
      5. VertexTangent+=VertexWeight*BlendShapeTangent
      6. For each PRT coefficient, c
         1. VertextPRT[c]+=VertexWeight*(PRTWeight0*BlendShapePRT[inde x0][c]+PRTWeight1*BlendShapePRT[index1][c])
4) After incorporating all blend shapes, apply deformation affine transform to vertex position:
   1. FinalPosition.x=BlendShapesPosition.x*VertAffineTransform.m00+BlendShapesPosition.y*VertAffineTransform.ml0+BasePosition.x
   2. FinalPosition.y=BlendShapesPosition.x*VertAffineTransform.m01+BlendShapesPosition.y*VertAffineTransform.m11+BasePosition.y
   3. FinalPosition.z=BasePosition.z

Furthermore, image processing system 118 may enable real-time character animation by performing high-quality normal and surface color animation from blend shapes. While the blend shape vertices perform large scale posing and animation, fine geometric details from blend shapes, like wrinkles, may be stored by image processing system as tangent space surface directions in blend shape normal maps. In addition, blend shape surface color changes are stored in albedo maps by image processing system 118. The albedo maps may include color shifts caused by changes in blood flow during each expression and lighting changes caused by small scale self-occlusion. The normal maps may include directional offsets from the base pose.

Image processing system 118 may compute the albedo maps as:

Blend Shape Albedo Map Color=0.5*Blend Shape Surface Color/Base Shape Surface Color

The 0.5 scale set forth in the foregoing equation may allow for a dynamic range of 0.0 to 2.0, so that the albedo maps can brighten the surface, as well as darken it. Other appropriate scaling factors may be used.

Image processing system 118 may compute the normal maps as:

Blend Shape Normal Map Color.rgb=(Blend Shape Tangent Space Normal.xyz−Base Model Tangent Space Normal.xyz)*0.5+0.5

The 0.5 scale and offset set forth in the foregoing equation may allow for a range of −1.0 to 1.0. Other appropriate scaling factors and offsets may be used.

The blend shape normal and albedo maps may provide much higher quality results. Using traditional methods, it may be impractical to use 50 normal map textures plus 50 albedo map textures for real-time rendering on commodity hardware, as this may be too slow for real-time rendering, and many commodity graphics processors are limited to a limited number (e.g., eight) of textures per pass.

To overcome these problems, image processing system 118 may first consolidate blend shapes referencing the same texture. The three-dimensional scanned blend shapes of the present disclosure may each have their own set of textures, but image processing system 118 nay also use some hand-created blend shapes that reference textures from a closest three-dimensional scan. Then, as described above, image processing system 118 may reduce the number of blend shapes (e.g., down to eight), while avoiding visual artifacts. Image processing system 118 may further copy the vertex positions from three-dimensional deformed head model 504 to a special blending model containing blending weights for a number (e.g., eight) of facial regions, packed into two four-dimensional texture coordinates. Image processing system 118 may render such number (e.g., eight) of blend shape normal map textures into an intermediate normal map buffer, optionally applying independent weighting for up to such number (e.g., eight) of facial regions.

Image processing system 118 may then render such number (e.g., eight) of blend shape albedo map textures into an intermediate albedo map buffer, optionally applying independent weighting for up to such number (e.g., eight) of facial regions, just like is done for the normal maps. In a third render pass, image processing system 118 may sample from the normal and albedo intermediate maps, using only a subset (e.g., two) out of the available (e.g., eight) textures. The remaining textures (e.g., six) may be available for other rendering effects. To perform the operations set forth in this paragraph, image processing system 118 may use the following processes to combine each set of (e.g., eight) textures:

1) Image processing system 118 may compute texture weights per vertex, combining, for example, 8 facial region vertex weights with 8 blend shape weights:

VertexRegionWeights#### is a four-dimensional vertex texture
coordinate value containing 4 region weights for that vertex.
BlendShape####WeightsRegion# is a four-dimensional uniform
parameter containing 4 blend shape weights for each region.
TextureWeightsXXXX is a four-dimensional vertex result value
containing four blend shape weights for the current vertex.
Remainder is a one-dimensional vertex result value with one minus
the sum of all the vertex weights.
TextureWeights0123 = VertexRegionWeights0123.x *
BlendShape0123WeightsRegion0 +VertexRegionWeights0123.y *
BlendShape0123WeightsRegion1 + VertexRegionWeights0123.z *
BlendShape0123WeightsRegion2 + VertexRegionWeights0123.w *
BlendShape0123WeightsRegion3 + VertexRegionWeights4567.x *
BlendShape0123WeightsRegion4 + VertexRegionWeights4567.y *
BlendShape0123WeightsRegion5+ VertexRegionWeights4567.z *
BlendShape0123WeightsRegion6 + VertexRegionWeights4567.w *
BlendShape0123WeightsRegion7
TextureWeights4567 = VertexRegionWeights0123.x *
BlendShape4567WeightsRegion0 + VertexRegionWeights0123.y *
BlendShape4567WeightsRegion1 + VertexRegionWeights0123.z *
BlendShape4567WeightsRegion2 + VertexRegionWeights0123.w *
BlendShape4567WeightsRegion3 + VertexRegionWeights4567.x *
BlendShape4567WeightsRegion0 + VertexRegionWeights4567.y *
BlendShape4567WeightsRegion1 + VertexRegionWeights4567.z *
BlendShape4567WeightsRegion2 + VertexRegionWeights4567.w *
BlendShape4567WeightsRegion3
half4 one = half4(1, 1, 1, 1);
Remainder = saturate(1 − (dot(TextureWeights0123, one) +
dot(TextureWeights4567, one)))

2) For each pixel, image processing system 118 may compute the blended normal/albedo value as follows:

Color = 0.5
Color.rgb *= Remainder
Color.rgb += TextureWeights0123.x * tex2D(BlendShapeTex0, uv).rgb
+ TextureWeights0123.y * tex2D(BlendShapeTex1, uv).rgb +
TextureWeights0123.z * tex2D(BlendShapeTex2, uv).rgb +
TextureWeights0123.w * tex2D(BlendShapeTex3, uv).rgb +
TextureWeights4567.x * tex2D(BlendShapeTex4, uv).rgb +
TextureWeights4567.y * tex2D(BlendShapeTex5, uv).rgb +
TextureWeights4567.z * tex2D(BlendShapeTex6, uv).rgb +
TextureWeights4567.w * tex2D(BlendShapeTex7, uv).rgb

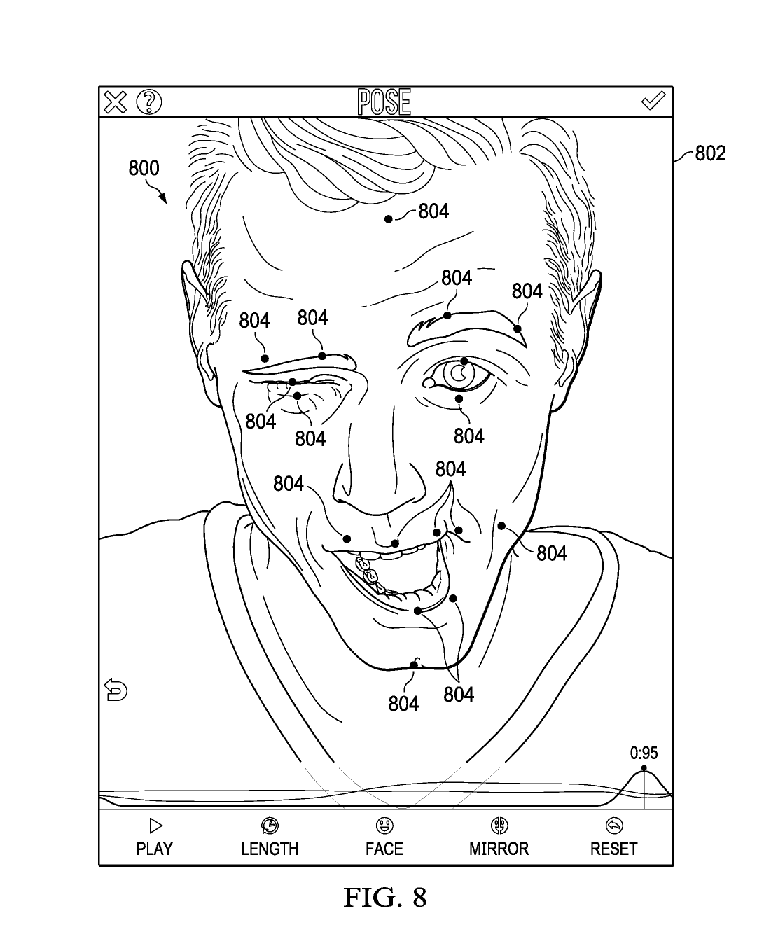

Further, image processing system 118 may perform high-quality rendering of a final character by combining blended vertex data, normal map data, and albedo map data with the extracted irradiant lighting data and surface color data for real-time display on a display device (e.g., on a display device of information handling system 100). FIG. 8 depicts rendering of a three-dimensional character 800 based upon the subject of two-dimensional image 300 on a display device 802. As shown in FIG. 8, three-dimensional character 800 may have associated therewith a plurality of interactive vertices 804, via which a user of an information handling system comprising display device 802 may interact via an appropriate I/O device 104 to animate character 800 as described in detail above.

To perform rendering, image processing system 118 may, for each vertex of three-dimensional deformed head model 504, compute a variable VertexShadow based on the blended precomputed radiance transfer coefficients calculated above and the dominant lighting direction and directionality, also determined above. Image processing system 118 may pass the remaining vertex values to pixel processing, wherein for each pixel:
OriginalAlbedo=Surface color pixel (calculated above)
LightingMask=Mask for crossfading between the animated face and the original background image.
BlendedAlbedo=Blended albedo buffer pixel (calculated above)
Albedo=4*OriginalAlbedo*BlendedAlbedo
TangentSpaceNormal=Base model normal map pixel*2−1
TangentSpaceNormal+=Blended normal buffer pixel*2−1
WorldNormal=TangentSpaceNormal transformed to world space
DiffuseLight=Irradiance Spherical Harmonic (calculated above) evaluated using the WorldNormal
SpecularLight=Computed using the extracting dominant lighting direction and dominant lighting color (calculated above)
PixelColor=VertexShadow*(Albedo*DiffuseLight+SpecularLight)

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented using CPU 102, image processing system 118 executing thereon, and/or any other system operable to implement method 200. In certain embodiments, method 200 may be implemented partially or fully in software and/or firmware embodied in computer-readable media.

Using the systems and methods set forth above, image processing system 118 may also enable the creation of interactive animation performances of a character using a keyboard of expression buttons. For example, all or a portion of method 200 described above may be performed by image processing system 118 to extract a three-dimensional character for use with real-time animation. Image processing system 118 may provide a keyboard of expression buttons, which may be a virtual keyboard displayed on a display device, in order for non-expert users to create interactive animations without the need to manipulate interactive vertices 804 as shown in FIG. 8. In a default state, image processing system 118 may use an “idle” animation to make the character appear to be “alive.” Each expression button may activate a unique pose or animation of character 800, and includes an image of a representative expression on such button. When a user interacts (e.g., via an I/O device 104) with an expression button, image processing system 118 may smoothly blend the associated pose or animation over the idle animation, with varying behavior depending on parameters specific to that pose or animation. In addition to playing expressions in isolation, image processing system 118 may play multiple expressions (e.g., in chords) in order to layer compound expressions; the resulting animation performance may then be recorded or transmitted as a compact sequence of button events.

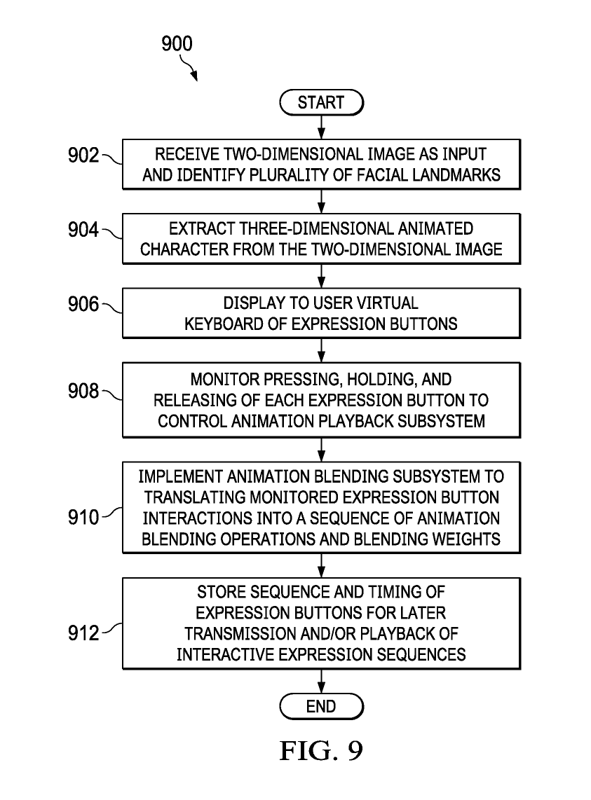

FIG. 9 illustrates a flow chart of an example method 900 for the creation of interactive animation performances of a character using a keyboard of expression buttons, in accordance with embodiments of the present disclosure. According to some embodiments, method 900 may begin at step 902. As noted above, teachings of the present disclosure may be implemented in a variety of configurations of information handling system 100. As such, the preferred initialization point for method 900 and the order of the steps comprising method 900 may depend on the implementation chosen.

At step 902, image processing system 118 may receive as an input a two-dimensional image comprising a face and may identify a plurality of facial landmarks (e.g., facial landmarks 304 of FIG. 3, above). At step 904, image processing system 118 may extract a three-dimensional animated character from the two-dimensional image, as described above with respect to portions of method 200.

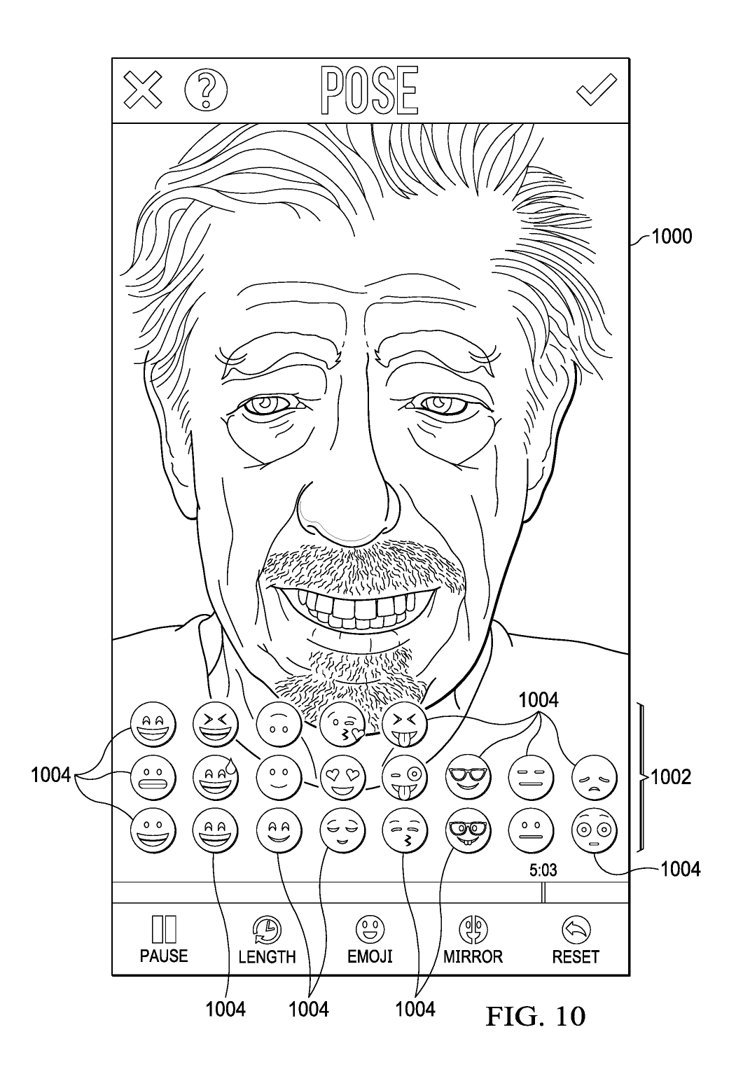

At step 906, image processing system 118 may display to a user a virtual keyboard of expression buttons, with each button representative of a unique facial expression or pose. For example, FIG. 10 illustrates an example display 1000 having a virtual keyboard 1002 of expression buttons 1004, in accordance with embodiments of the present disclosure. As shown in FIG. 10, each expression button 1004 may be labeled with a representative expression image. Thus, virtual keyboard 1002 of expression buttons 1004 may provide a user of an information handling system 100 a palette of expression options for which the user can interact (e.g., via mouse point or click or pressing the appropriate location of a touch-screen display) individually with a single expression button 1004 or in combinations of expression buttons 1004, similar to playing chords on a piano. Expression buttons 1004 may provide a non-expert user the ability to create interactive animation performances of a three-dimensional animated character. For more advanced users, in some embodiments, image processing system 118 may also provide the ability to scale an intensity of an animation associated with an expression button 1004. For example, normally, pressing and holding a single expression button may play the associated animation at 100% intensity. However, in some embodiments, image processing system 118 may include a mechanism for allowing a user to manipulate expression buttons 1004 to scale intensity of an associated animation (e.g., between 0% and 150% or some other maximum scaling factor). As a specific example, in such embodiments, virtual keyboard 1002 may be configured to allow a user to slide an expression button 1004 (e.g., vertically up and down), thus allowing a user to control the intensity of the animation associated with an expression button 1004 over time (e.g., for direct expressive control of the strength of the animation and the transition to and from each animation).

Turning again to FIG. 9, at step 908, image processing system 118 may monitor the pressing, holding, and releasing of each expression button 1004 to control an animation playback subsystem, such that, as described below, the results of the animation system are rendered interactively using the three-dimensional animated character extracted in step 904.

At step 910, image processing system 118 may implement an animation blending subsystem responsible for translating the monitored expression button 1004 interactions into a sequence of animation blending operations and blending weights. In some embodiments, the choice of blending operations and weights may depend on order of button events and parameters associated with the individual expression. These blending operations and weights can be used on any type of animation data. Image processing system 118 may apply regional blend shape animation, so that the animation data is a list of blend shape weights, individually specified for each region of the animated character's face. Image processing system 118 may in turn use the blend shape weights to apply offsets to vertex positions and attributes. Alternatively, image processing system 118 may use the list of blending operations and weights directly on vertex values for vertex animation, or on bone orientation parameters for skeletal animation. All of the animation blending operations also apply to poses (as exposed to expressions) associated with expression buttons 1004, and a pose may be treated as one-frame looping animation.

The parameters are associated with each expression may include:
1) Blend in
   a. Time
   b. Starting slope
   c. Ending slope
2) Blend out
   a. Time
   b. Starting slope
   c. Ending slope
3) Blend operation
   a. Add
   b. Crossfade
4) Minimum time
5) End behavior:
   a. Loop
   b. Hold the last frame
   c. Stop
6) Region mask

For the starting transition of an expression, image processing system 118 may apply the following formula to calculate a blend weight:
u=Time/BlendInTime
m1=BlendInStartingSlope
m2=BlendInEndingSlope

Weight=(−2+m2+m1)u³+(3−m2−2×m1)u²+m1×u

Image processing system 118 may use a similar formula for the ending transition of an expression, except for blending in the opposite direction:
u=Time/BlendOutTime
m1=BlendOutStartingSlope
m2=BlendOutEndingSlope

Weight=1−((−2+m2+m1)u³+(3−m2−2×m1)u²+m1×u)

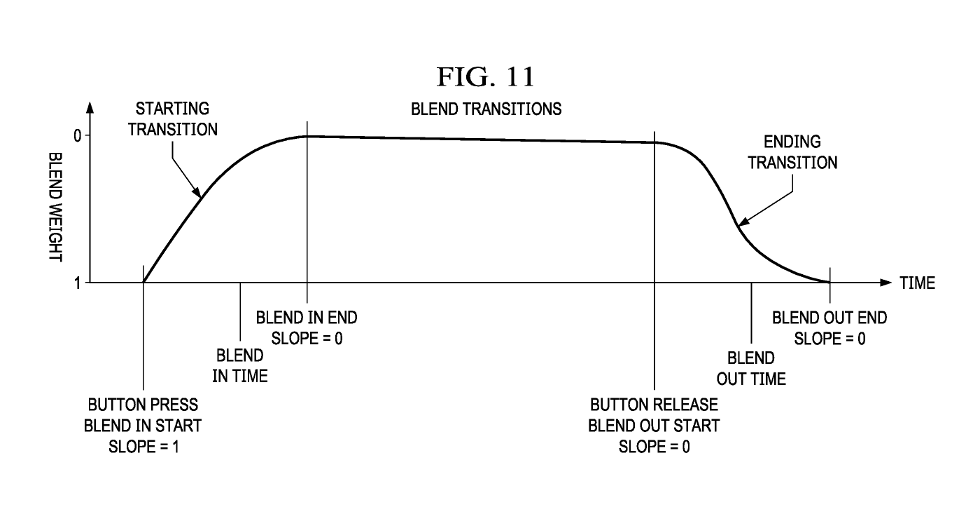

To further illustrate the application of blend weights and blend transitions for an expression, FIG. 11 illustrates an example graph of blend weight versus time for blending an expression, in accordance with embodiments of the present disclosure.

Given a blend weight of u, image processing system 118 may perform an add blend operation given by:

Result=OldValue+u*NewValue

Further, given a blend weight of u, image processing system 118 may perform a crossfade blend operation given by:

Result=OldValue+u*(NewValue−OldValue)

Image processing system 118 may apply these blending operations, order of expression button presses, and region masks (further described below) to determine how multiple simultaneous button presses are handled. In some embodiments, the add blend operation may be commutative and the crossfade blend operation may be noncommutative, so the order of button presses and blending can influence the final results.

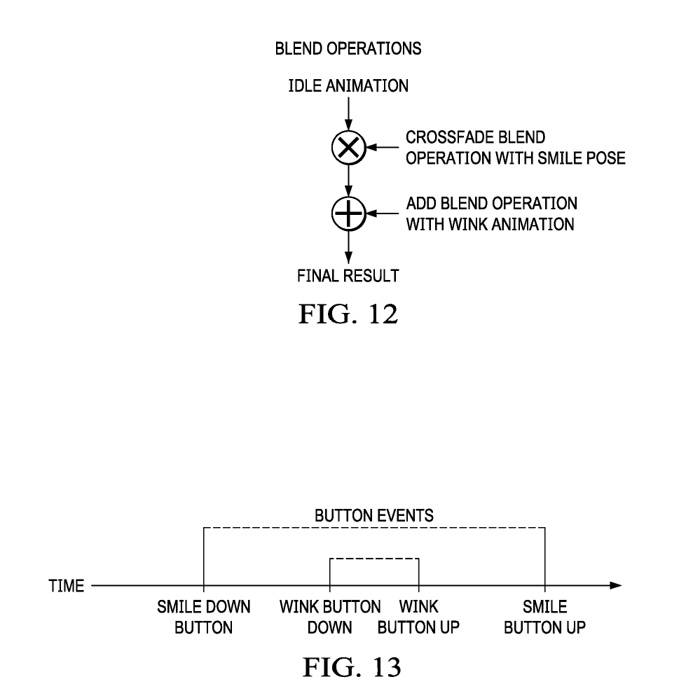

FIG. 12 illustrates an example flow diagram of applying blend operations in response to presses of expression buttons 1004 for a smile pose for applying a smile to the three-dimensional animated character and a wink animation to the three-dimensional animated character, in accordance with embodiments of the present disclosure. For example, in response to user interaction with an expression button 1004 for a smile pose, image processing system 118 at 1202 may perform a crossfade blend operation to crossfade blend an idle animation with the smile pose. Further, in response to a subsequent user interaction with an expression 1004 button for a wink expression, image processing system 118 at 1204 may perform an add blend operation to add the wink expression to the idle animation as crossfaded with the smile from 1202, providing a final result in which the three-dimensional animated character is animated to have a smile and to wink.

A region mask, as mentioned above, may comprise a list of flags that defines to which regions of the three-dimensional character a blend operation is applied. Other regions not defined in the region mask may be skipped by the blending operations. Alternatively, for skeletal animation, a region mask may be replaced by a bone mask.

In some embodiments, each expression associated with an expression button 1004 may have associated therewith a minimum time which sets a minimum length for playback of the animation for the expressions. For example, if a minimum time for an expression is zero, the animation for the expression may begin when the corresponding expression button 1004 is pushed and may stop as soon as the corresponding expression button 1004 is released. However, if a minimum time for an expression is non-zero, the animation for the expression may play for the minimum time, even if the corresponding expression button 1004 is released prior to expiration of the minimum time.

Each expression may also include an end behavior that defines what happens at the end of an animation. For example, an expression may have an end behavior of “loop” such that the animation for the expression is repeated until its associated expression button 1004 is released. As another example, an expression may have an end behavior of “hold” such that if the animation ends before the corresponding expression button 1004 is released, the animation freezes on its last frame until the expression button 1004 is released. As a further example, an expression may have an end behavior of “stop” such that the animation stops when it reaches its end, even if its corresponding expression button 1004 remains pressed. If there is a non-zero blend out time, an ending transition may begin for the end of the animation, to insure that the blending out of an animation is complete prior to the end of the animation.

Turning again to FIG. 9, at step 912, image processing system 118 may store the sequence and timing of expression buttons 1004 for later transmission and/or playback of interactive expression sequences. Although animation data itself may require a substantial amount of data, the sequence and timing of expression button events may be extremely compact. Such compactness may be valuable for efficiently storing and transmitting animation data. After loading or transmission, a sequence of button events can be replayed by the blending described above with respect to step 910, in order to reconstruct the animation either on the original three-dimensional character or another three-dimensional character. Transmission of a sequence of button events may happen either for a complete animation, or in real time, for example as one user performs a sequence of button presses to be consumed by other users.

FIG. 13 illustrates a graphical depiction of a data element that may be used by image processing system 118 to store the sequence and timing of expression buttons for later transmission and/or playback of interactive expression sequences, in accordance with embodiments of the present disclosure. As shown in FIG. 13, each data element may include a button identifier (e.g., “smile,” “wink”), an event type (e.g., “button up” for a release of an expression button 1004 and “button down” for a press of an expression button 1004), and a time of event, which can be given in any suitable time format (e.g., absolute time such as Universal Time Code, time offset since the start of performance of the animation, time offset since the last event, etc.).

In the case of unreliable transmission of the sequence of events (e.g., via a networked connection), it is possible that a button event is lost. To avoid a scenario in which a data element would represent an expression button being “stuck” in a pressed position, an image processing system 118 on a receiving end of the transmission of a sequence of events may automatically add an event to release an expression button after a predetermined timeout duration. In such situations, in order to reproduce intentional long presses of an expression button, a user at the sending end of a transmission may need to transmit periodic button down events on the same button, in order to reset the timeout duration.

Although FIG. 9 discloses a particular number of steps to be taken with respect to method 900, method 900 may be executed with greater or fewer steps than those depicted in FIG. 9. In addition, although FIG. 9 discloses a certain order of steps to be taken with respect to method 900, the steps comprising method 900 may be completed in any suitable order.

Method 900 may be implemented using CPU 102, image processing system 118 executing thereon, and/or any other system operable to implement method 900. In certain embodiments, method 900 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding this disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A computer-implementable method comprising:
receiving a two-dimensional image comprising a face of a subject;
deforming a three-dimensional base head model to conform to the face in order to generate a three-dimensional deformed head model;
deconstructing the two-dimensional image into three-dimensional components of geometry, texture, lighting, and camera based on the three-dimensional deformed head model; and
generating a three-dimensional character from the two-dimensional image based on the deconstructing.

2. The method of claim 1, further comprising:
animating the three-dimensional character based on the three-dimensional components and data associated with the three-dimensional deformed head model; and
rendering the three-dimensional character as animated based on the three-dimensional components and data associated with the three-dimensional deformed head model to a display device associated with an information handling system.

3. The method of claim 1, wherein generating the three-dimensional character comprises computing a three-dimensional head orientation, scale, and camera distance from the two-dimensional image by minimizing a facial landmark distance error and minimizing a shading error between the two-dimensional image and the three-dimensional base head model.

4. The method of claim 3, wherein generating the three-dimensional character comprises computing a per-vertex affine transform to transfer blend shapes from the three-dimensional base head model to the three-dimensional deformed head model.

5. The method of claim 4, further comprising:
animating the three-dimensional geometry and texture by animating vertices associated with the face of the subject from the blend shapes and using the per-vertex affine transform to generate blended vertex data; and
rendering the three-dimensional character as animated by animating the three-dimensional geometry and texture to a display device associated with an information handling system.

6. The method of claim 5, wherein rendering the three-dimensional character comprises combining the blended vertex data, a normal map associated with the face of the subject, and an albedo map associated with the face of the subject with extracted irradiant lighting information from the two-dimensional image based on luminance of skin regions and eye white regions of the face of the subject and surface color texture information from the two-dimensional image based on the irradiant lighting information and a simulation of lighting and shadows of the face of the subject.

7. The method of claim 1, wherein generating the three-dimensional character comprises extracting irradiant lighting information from the two-dimensional image based on luminance of skin regions and eye white regions of the face of the subject.

8. The method of claim 5, wherein generating the three-dimensional character further comprises determining surface color texture information from the two-dimensional image based on the irradiant lighting information and a simulation of lighting and shadows of the face of the subject.

9. The method of claim 1, further comprising:
displaying to a user of an information handling system the three-dimensional character and a virtual keyboard of expression buttons, each expression button associated with an animation of the three-dimensional character;
monitoring interactions of the user with the expression buttons;
translating the interactions into a sequence of animation blending operations and blending weights for animation of the three-dimensional character; and
animating and rendering the three-dimensional character in accordance with the sequence of animation blending operations and blending weights.

10. The method of claim 9, further comprising storing data elements associated with a sequence and timing of the interactions for at least one of later transmission of the sequence and timing of the interactions and later playback of the sequence and timing of the interactions to animate the three-dimensional character or another three-dimensional character.

11. The method of claim 1, wherein deforming the three-dimensional base head model to conform to the face in order to generate the three-dimensional deformed head model comprises applying perspective space deformation of the three-dimensional base head model to conform to the face.

12. A non-transitory, computer-readable storage medium embodying computer program code, the computer program code comprising computer executable instructions configured for:
receiving a two-dimensional image comprising a face of a subject;
deforming a three-dimensional base head model to conform to the face in order to generate a three-dimensional deformed head model;
deconstructing the two-dimensional image into three-dimensional components of geometry, texture, lighting, and camera based on the three-dimensional deformed head model; and
generating a three-dimensional character from the two-dimensional image based on the deconstructing.

13. The computer-readable storage medium of claim 12, the executable instructions further configured for:
animating the three-dimensional character based on the three-dimensional components and data associated with the three-dimensional deformed head model; and
rendering the three-dimensional character as animated based on the three-dimensional components and data associated with the three-dimensional deformed head model to a display device associated with an information handling system.

14. The computer-readable storage medium of claim 12, wherein generating the three-dimensional character comprises computing a three-dimensional head orientation, scale, and camera distance from the two-dimensional image by minimizing a facial landmark distance error and minimizing a shading error between the two-dimensional image and the three-dimensional base head model.

15. The computer-readable storage medium of claim 14, wherein generating the three-dimensional character comprises computing a per-vertex affine transform to transfer blend shapes from the three-dimensional base head model to the three-dimensional deformed head model.

16. The computer-readable storage medium of claim 15, the executable instructions further configured for:
animating the three-dimensional geometry and texture by animating vertices associated with the face of the subject from the blend shapes and using the per-vertex affine transform to generate blended vertex data; and
rendering the three-dimensional character as animated by animating the three-dimensional geometry and texture to a display device associated with an information handling system.

17. The computer-readable storage medium of claim 16, wherein rendering the three-dimensional character comprises combining the blended vertex data, a normal map associated with the face of the subject, and an albedo map associated with the face of the subject with extracted irradiant lighting information from the two-dimensional image based on luminance of skin regions and eye white regions of the face of the subject and surface color texture information from the two-dimensional image based on the irradiant lighting information and a simulation of lighting and shadows of the face of the subject.

18. The computer-readable storage medium of claim 12, wherein generating the three-dimensional character comprises extracting irradiant lighting information from the two-dimensional image based on luminance of skin regions and eye white regions of the face of the subject.

19. The computer-readable storage medium of claim 18, wherein generating the three-dimensional character further comprises determining surface color texture information from the two-dimensional image based on the irradiant lighting information and a simulation of lighting and shadows of the face of the subject.

20. The computer-readable storage medium of claim 12, the executable instructions further configured for:
displaying to a user of an information handling system the three-dimensional character and a virtual keyboard of expression buttons, each expression button associated with an animation of the three-dimensional character;
monitoring interactions of the user with the expression buttons;
translating the interactions into a sequence of animation blending operations and blending weights for animation of the three-dimensional character; and
animating and rendering the three-dimensional character in accordance with the sequence of animation blending operations and blending weights.

21. The computer-readable storage medium of claim 20, the executable instructions further configured for storing data elements associated with a sequence and timing of the interactions for at least one of later transmission of the sequence and timing of the interactions and later playback of the sequence and timing of the interactions to animate the three-dimensional character or another three-dimensional character.

22. The computer-readable storage medium of claim 12, wherein deforming the three-dimensional base head model to conform to the face in order to generate the three-dimensional deformed head model comprises applying perspective space deformation of the three-dimensional base head model to conform to the face.
